(19) United States
(12) Patent Application Publication
(10) Pub. No.: US 2019/0128021 A1
(43) Pub. Date: May 2, 2019

(54) CLUTCH FOR ACTUATOR-DRIVEN LOCK ASSEMBLY

(71) Applicant: Mul-T-Lock Technologies Ltd., Yavne (IL)

(72) Inventor: Leon Notkin, Rehovot (IL)

(73) Assignee: Mul-T-Lock Technologies Ltd., Yavne (IL)

(21) Appl. No.: 16/302,653

(22) PCT Filed: Apr. 25, 2017
(86) PCT No.: PCT/IB2017/052369

§ 371 Date: Nov. 18, 2018

(30) Foreign Application Priority Data
May 31, 2016 (IL) 245947

(51) Int. Cl. E05B 47/00

(52) U.S. Cl. CPC E05B 47/0012; E05B 2047/0091; E05B 2047/0083; E05B 2047/0026

(57) ABSTRACT

A lock assembly (10) includes a non-manual actuator (12) coupled to a drive member (37), and a clutch member (38) formed with a groove (39) in which an engagement element (62) is disposed. The engagement element (62) is movable towards and away from a cam surface (46) which is arranged to move a lock element (56). The lock element (56) is also connected to a manual actuator (60). In a first orientation, the engagement element (62) does not protrude out of the groove (39) and does not abut against the cam surface (46), so that the non-manual actuator (12) is disengaged from the lock element (56). In a second orientation, the drive member (37) is movable by the non-manual actuator (12) so that the drive member (37) causes the engagement element (62) to protrude out of the groove (39) and abut against the cam surface (46), so that the non-manual actuator (12) is engaged with the lock element (56).

### FIELD OF THE INVENTION

The present invention relates generally to actuator-driven locks, such as electromechanical, hydraulic or pneumatic locks, and particularly to a clutch that selectively engages or disengages an actuator from turning a lock mechanism.

### BACKGROUND OF THE INVENTION

Electromechanical locks (e.g., cylinder locks) are known which are operated by means of some actuator (e.g., a gear motor) and which are manually operable as well.

The drive motor is typically mounted in an escutcheon on an inner face of the door or on some internal part of the door. The drive motor has a driveshaft for transmitting rotation to the cylinder lock, typically to a shaft extending from the cylinder lock. When the drive motor is electrically energized, it causes actuation (e.g., rotation) of the cam to open or close the locking bolts. The drive motor is typically energized by a transponder in a key or other device.

If the motor were engaged at all times with the lock shaft, manual operation would require the manual turning torque to overcome the added torque load of the motor, which may be difficult for some users, especially old or invalid persons. A clutch may be connected between the motor and the lock shaft, which selectively engages or disengages the motor from the lock shaft. With the motor disengaged, the lock can be operated manually without the motor adding excessive torque.

### SUMMARY OF THE INVENTION

The present invention seeks to provide an improved clutch for actuator-driven locks, such as electromechanical, hydraulic or pneumatic locks. The clutch selectively engages or disengages a non-manual actuator from turning a lock mechanism and has a simplified and inexpensive construction, as described more in detail hereinbelow. The invention is simpler and less expensive to manufacture and assemble than electromechanical clutches, solenoids and the like. The invention is more reliable than mechanical ratchet systems, which require springs for their operation.

There is thus provided in accordance with an embodiment of the present invention a lock assembly including a non-manual actuator coupled to a drive member; and a clutch member formed with a groove in which an engagement element is disposed, the engagement element being movable towards and away from a cam surface which is arranged to move a lock element, the lock element also being connected to a manual actuator, wherein in a first orientation, the engagement element does not protrude out of the groove and does not abut against the cam surface, so that the non-manual actuator is disengaged from the lock element, and in a second orientation, the drive member is movable by the non-manual actuator so that the drive member causes the engagement element to protrude out of the groove and abut against the cam surface, so that the non-manual actuator is engaged with the lock element.

In accordance with an embodiment of the present invention the non-manual actuator is operative to move the drive member back from the second orientation to the first orientation.

In accordance with an embodiment of the present invention at least one sensor is arranged to sense movement of the lock element or the non-manual actuator.

In accordance with an embodiment of the present invention the drive member has concave sides.

In accordance with an embodiment of the present invention the clutch member cooperates with a wheel that has spokes that extend from a hub with spaces between the spokes, and the clutch member includes protruding lugs that enter the spaces.

In accordance with an embodiment of the present invention the clutch member is formed with at least two diametrically opposed grooves.

In accordance with an embodiment of the present invention the cam surface is connected to a drive gear operative to move the lock element. The clutch member may be received in a recess formed in an interface hub of the drive gear. The drive gear may mesh with another gear operatively connected to the lock element.

### BRIEF DESCRIPTION OF THE DRAWINGS

The present invention will be understood and appreciated more fully from the following detailed description, taken in conjunction with the drawings in which:

FIGS. 1 and 2 are simplified exploded and side-view illustrations of a lock assembly, constructed and operative in accordance with a non-limiting embodiment of the present invention; and

FIGS. 3A-3F are simplified illustrations of a clutch mechanism for use with the lock assembly of FIGS. 1 and 2, wherein FIGS. 3A and 3B are lower and upper (in the sense of the drawings) illustrations, respectively, of a drive member, clutch member and drive gear, with the drive member disengaged from the drive gear by means of the clutch member so that the non-manual actuator of the lock assembly is disengaged from the drive gear, FIGS. 3C and 3D are lower and upper illustrations, respectively, of the drive member starting to be rotated by the non-manual actuator but still disengaged from the drive gear, and FIGS. 3E and 3F are lower and upper illustrations, respectively, of the drive member rotated sufficiently by the non-manual actuator to be engaged with the drive gear by the clutch mechanism.

### DETAILED DESCRIPTION OF EMBODIMENTS

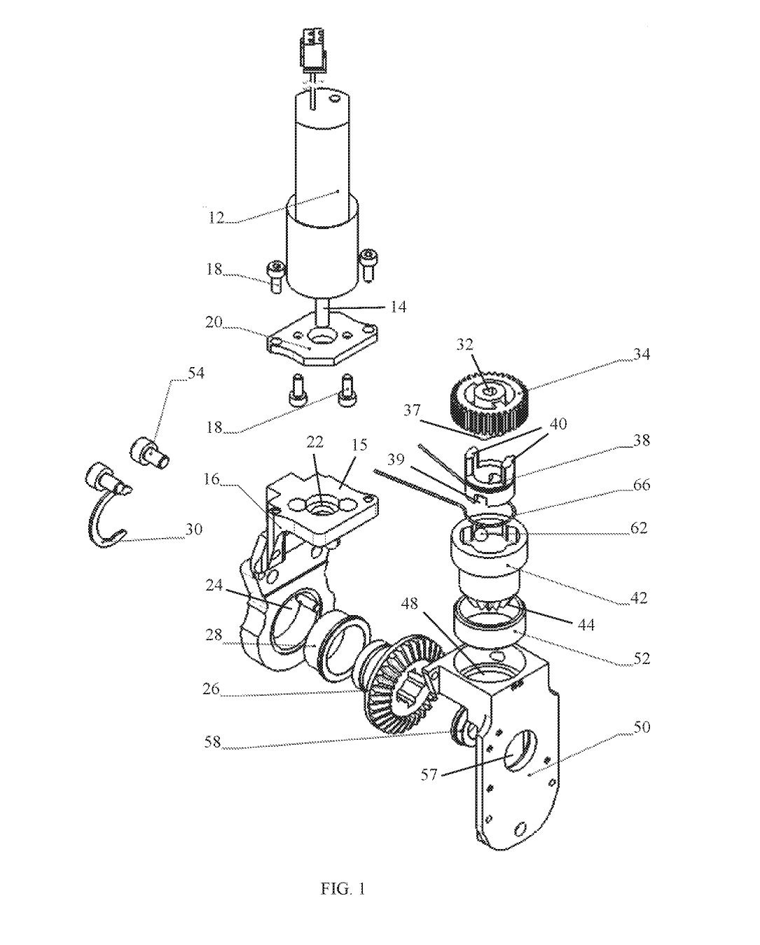

Reference is now made to FIG. 1, which illustrates a lock assembly 10, constructed and operative in accordance with a non-limiting embodiment of the present invention. Lock 10 includes a non-manual actuator 12 (such as, but not limited to, a gear motor, step motor or pneumatic or hydraulic actuator). In the illustrated embodiment, non-manual actuator 12 is a gear motor with a drive shaft 14, the motor being secured to a flange 15 of a housing 16, such as by means of fasteners 18 and an intermediate plate 20. Flange 15 is formed with an aperture 22 for the drive shaft 14 to pass through.

Housing 16 has a bore 24 transverse to the drive shaft 14. A bevel gear 26 is rotatingly mounted in bore 24 by means of a bushing (bearing) 28. A circlips 30 may be mounted on the other side of bevel gear 26 to retain gear 26 from moving out of housing 16.

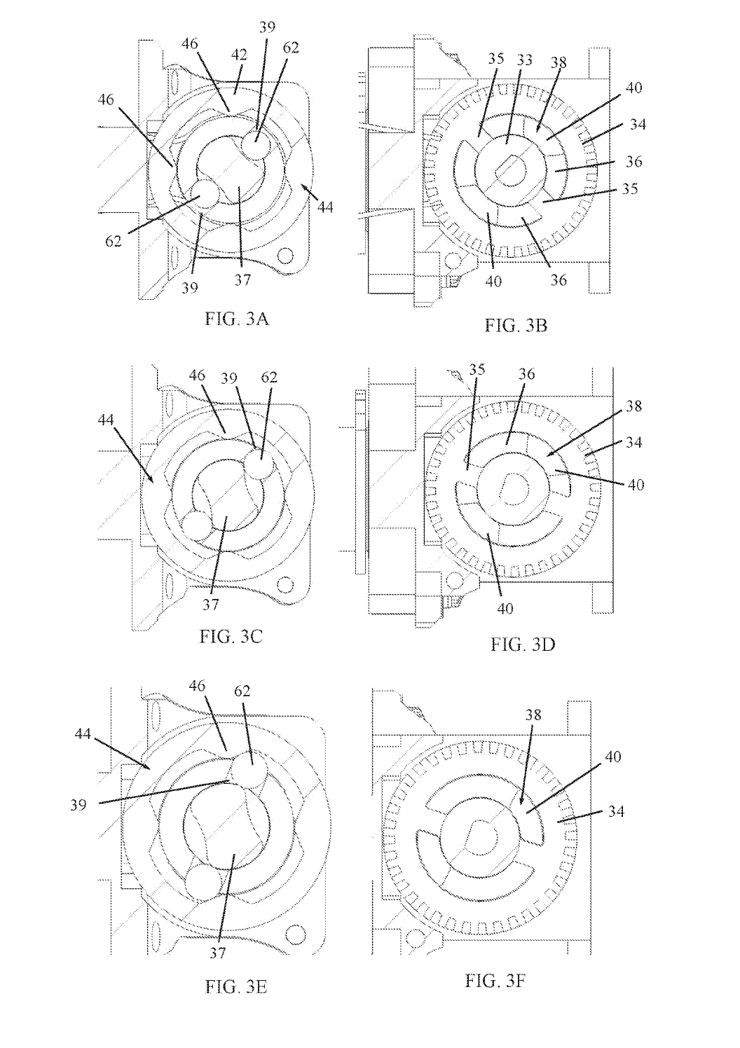

The drive shaft 14 enters a hole 32 (which may be keyed in a D-shape) formed in a hub 33 (FIG. 3B) of a wheel or gear wheel 34. As seen in FIG. 3B, gear wheel 34 has two spokes 35 that extend from hub 33 with spaces 36 between the spokes 35. A clutch member 38 has protruding lugs 40 that enter spaces 36. As seen in FIG. 3A, wheel 34 has a (lower, in the sense of the drawings) drive member 37 which may have concave sides. Drive member 37 may alternatively be separate from wheel 34. Clutch member 38 is formed with one or more grooves 39, such as two or more diametrically opposed grooves 39 (also seen in FIG. 3A). It is noted that in the illustrated embodiment, the non-manual actuator 12 rotates drive member 37; alternatively, non-manual actuator 12 may be designed to move drive member 37 linearly or in other motions.

Referring again to FIG. 1, clutch member 38 is received in a recess formed in an interface hub 42 of a drive gear 44. As seen in FIG. 3A, interface hub 42 may be formed with a plurality of inwardly facing cam surfaces 46 (four are provided in the illustrated embodiment, but the invention is not limited to this number). (Alternatively, the cam surfaces could be depressions or other shapes instead of protrusions.) Drive gear 44 is journaled in a bushing (bearing) 52 mounted in a bore 48 formed in a bracket 50. Drive gear 44 is beveled and meshes with bevel gear 26. Other types of gears and meshings may be used to carry out the invention, such as but not limited to, spur gears, worm gears, belts, hooks and others. Bracket 50 may be secured to housing 16 by means of fasteners 54.

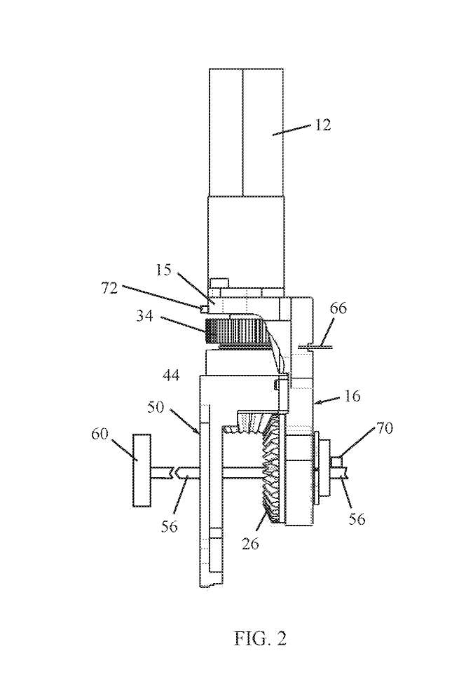

The assembled lock is shown in FIG. 2. Gear 26 is operatively connected to a lock element 56, such as a lock shaft 56 of a locking mechanism (not shown), which is journaled in a bore 57 (FIG. 1) of bracket 50 by means of a bushing (bearing) 58. Lock shaft 56 is also connected to a manual actuator 60 (FIG. 2), such as but not limited to, a handle or knob.

The clutch member 38 cooperates with one or more engagement elements 62 (such as, but not limited to, balls 62 or cylinders or other shapes), received in interface hub 42 of the drive gear 44, to form a clutch mechanism that selectively engages and disengages the actuator 12 (its drive shaft 14) with drive gear 44, as will now be described with reference to FIGS. 3A-3F. When drive shaft 14 is disengaged by the clutch mechanism from turning drive gear 44, the manual actuator 60 can easily turn the lock shaft 56 of the locking mechanism without the added burden of the non-manual actuator 12 (so that the non-manual actuator 12 plays no part in turning the lock shaft 56).

Reference is now made to FIGS. 3A-3F. In FIGS. 3A and 3B, engagement elements 62 do not protrude outwards of grooves 39. The drive member 37 is disengaged from the interface hub 42 of the drive gear 44; hub 42 turns independently of drive member 37. Thus, drive member 37 plays no part in turning the interface hub 42 of the drive gear 44, and the non-manual actuator of the lock assembly is disengaged from the drive gear 44.

In FIGS. 3C and 3D, the drive member 37 is starting to be rotated (clockwise in FIG. 3C and counterclockwise in the sense of FIG. 3D) by the actuator but is still disengaged from the drive gear 44 because engagement elements 62 still do not protrude outwards of grooves 39.

In FIGS. 3E and 3F, the drive member 37 has been rotated sufficiently by the actuator so that drive member 37 move (e.g., pushes) engagement elements 62 so they now protrude outwards of grooves 39 and abut against cam surfaces 46 of drive gear 44. The protruding lugs 40 of clutch member 38 now abut against spokes 35 of gear wheel 34. In this manner, the non-manual actuator is now engaged with the drive gear 44 by the clutch mechanism and the non-manual actuator can rotate drive gear 44 to rotate the lock shaft 56 of the assembly via the bevel gear 26 (not seen in FIGS. 3E-3F).

After the non-manual actuator has rotated drive gear 44 to rotate the lock shaft 56 of the assembly, a sensor 70, shown in FIG. 2, (such as, but not limited to, a potentiometer, optical sensor, encoder or other sensor) may sense that lock shaft 56 has been moved to the end of its travel and signal the non-manual actuator to reverse its direction of movement, thereby moving drive member 37 back to its original position of FIG. 3A, in which the non-manual actuator is once again disengaged from lock shaft 56. The reverse movement of the non-manual actuator may be sensed by another sensor 72, shown in FIG. 2, (such as, but not limited to, a potentiometer, optical sensor, encoder or other sensor) that senses movement of wheel 34. Sensor 72 ensures that the non-manual actuator returns to the original position.

A biasing member 66, such as a spring rod, may be assembled on an outside groove of clutch member 38 to apply tension to clutch member 38. The biasing member 66 ensures there is sufficient friction between clutch member 38 and wheel 34 so that only wheel 34 moves and clutch member 38 does not move during the reverse movement of the non-manual actuator 12. Other methods may be used instead of the biasing member 66, such as but not limited to, friction enhancing surfaces, one-way mechanisms, etc.

1. A lock assembly comprising:
a non-manual actuator coupled to a drive member; and
a clutch member formed with a groove in which an engagement element is disposed, said engagement element being movable towards and away from a cam surface which is arranged to move a lock element, said lock element also being connected to a manual actuator;
wherein in a first orientation, said engagement element does not protrude out of said groove and does not abut against said cam surface, so that said non-manual actuator is disengaged from said lock element, and in a second orientation, said drive member is movable by said non-manual actuator so that said drive member causes said engagement element to protrude out of said groove and abut against said cam surface, so that said non-manual actuator is engaged with said lock element;
and wherein at least one sensor is configured to sense movement of said lock element or said non-manual actuator, and is also configured to sense that said lock element has been moved to an end of its travel and to signal said non-manual actuator to reverse its direction of movement, thereby moving said drive member so that said non-manual actuator is once again disengaged from said lock element.

2. The lock assembly according to claim 1, wherein said non-manual actuator is operative to move said drive member back from the second orientation to the first orientation.

3. The lock assembly according to claim 1, wherein said at least one sensor comprises a first sensor and a second sensor, wherein the first sensor is configured to sense movement of said lock element or said non-manual actuator, and said second sensor is configured to sense reverse movement of said non-manual actuator.

4. The lock assembly according to claim 1, wherein said drive member has concave sides.

5. The lock assembly according to claim 1, wherein said clutch member cooperates with a wheel that has spokes that extend from a hub with spaces between said spokes, and said clutch member comprises protruding lugs that enter said spaces.

6. The lock assembly according to claim 1, wherein said clutch member is formed with at least two diametrically opposed grooves.

7. The lock assembly according to claim 1, wherein said cam surface is connected to a drive gear operative to move said lock element.

8. The lock assembly according to claim 7, wherein said clutch member is received in a recess formed in an interface hub of said drive gear.

9. The lock assembly according to claim 7, wherein said drive gear meshes with another gear operatively connected to said lock element.

10. The lock assembly according to claim 1, wherein a biasing member applies tension to said clutch member.

11. The lock assembly according to claim 1, wherein a biasing member, a friction enhancing surface, or a one-way mechanism ensures there is sufficient friction between said clutch member and said wheel so that only said wheel moves and said clutch member does not move during reverse movement of said non-manual actuator.
